(19) United States
(12) Patent Application Publication
(10) Pub. No.: US 2014/0087974 A1
(43) Pub. Date: Mar. 27, 2014

(54) Particulate Weighting Agents Comprising Removable Coatings and Methods of Using the Same

(71) Applicant: HALLIBURTON ENERGY SERVICES, INC., Houston, TX (US)

(72) Inventors: Alfredo Villarreal, Houston, TX (US); William Walter Shumway, Houston, TX (US)

(73) Assignee: Halliburton Energy Services, Inc., Houston, TX (US)

(21) Appl. No.: 13/628,744

(22) Filed: Sep. 27, 2012

(51) Int. Cl. C09K 8/035; C09K 8/62; E21B 43/26; E21B 43/25; C09K 8/42; E21B 33/14

(52) U.S. Cl. 507/110; 507/117; 106/804; 523/130; 166/305.1; 166/308.1; 166/292

(57) ABSTRACT

Additives used in treatment fluids include particulate weighting agents comprising removable coatings which can be used in methods such as drilling and cementing operations; a method includes providing a treatment fluid for use in a subterranean formation, the treatment fluid including a coated particulate weighting agent including a core weighting agent having a first specific gravity and a removable polymer coating having a second specific gravity, the first specific gravity and the second specific gravity are not the same, introducing the treatment fluid into the subterranean formation, and allowing a portion of the removable polymer coating to be removed to alter the specific gravity of the coated particulate weighting agent down hole.

### BACKGROUND

The present invention relates to additives used in treatment fluids in subterranean operations. More specifically, the present invention relates to particulate weighting agents comprising removable coatings and methods of using the same in treatment fluids as part of subterranean operations such as drilling and cementing operations.

Treatment fluid roles include, for example, stabilizing the well bore and controlling the flow of gas, oil or water from the formation to prevent the flow of formation fluids or to prevent the collapse of pressured earth formations. The column of a treatment fluid exerts a hydrostatic pressure proportional to the depth of the hole and the density of the fluid. For example, some high-pressure formations can require a fluid with a density as high as 3.0 SG.

Varieties of materials are presently used to increase the density of treatment fluids, including the use of dissolved salts such as sodium chloride, calcium chloride and calcium bromide. Alternatively, the density of a treatment fluid may be altered by means of a particulate weighting agent. Particulate weighting agents may include powdered minerals such as barite, calcite, and hematite that increase the density of a fluid when suspended therein. The use of a finely divided metal, such as iron, as a particulate weighting agent in a drilling fluid has also been described. Finely powdered calcium or iron carbonate has also been used; however, the plastic viscosity of such fluids rapidly increases as the particle size decreases, thus limiting the utility of these materials.

Another demand on a typical particulate weighting agent is that it should form a stable suspension that does not readily settle out. Secondarily, the suspension may beneficially exhibit a low viscosity to facilitate pumping and minimize the generation of high pressures. Ideally, the treatment fluid slurry should also exhibit low fluid loss. Conventional particulate weighting agents, such as powdered barite, may require the addition of a gellant such as bentonite for water-based fluids, or organically modified bentonite for oil-based fluids. A soluble polymer viscosifier may be also added to slow the rate of the sedimentation of the weighting agent. However, as more gellant is added to increase the suspension stability, the fluid viscosity (plastic viscosity and/or yield point) increases undesirably.

Sub-micron or micronized particles have also been employed as particulate weighting agents with the benefit of preventing sag. Sag is the settling of particulate weighting agents that can occur when a treatment fluid is static or being circulated. Sag is particularly problematic when it occurs to a static fluid in the annulus of a wellbore. While static fluids are known to be problematic, due to of the combination of secondary flow and gravitational forces, particulate weighting agents can sag in a flowing mud in a high-angle well. If settling is prolonged, the upper part of a wellbore may lose mud density, which lessens the hydrostatic pressure in the hole, potentially causing an influx of formation fluid into the well. While sub-micron particulate weighting agents may serve to prevent sag, other issues with their use arise related to increased plastic viscosity and transferability properties.

The issues raised with the use of sub-micron particulate weighting agents have been addressed, in part, using surfactant-based coatings to help disperse the particles in the base fluid. However, in such applications, the surfactants are only weakly linked to the surface of the particles and the adherence of the surfactant to the particle competes with other phenomenon such as the formation of emulsion droplets and/or the interaction of the surfactant with other solids that may have a higher affinity for the surfactant than the weighting particle.

In contrast to the highly labile surfactant-coated particulate weighting agents described above, other coatings have been used to encapsulate particulate weighting agents, thus providing a more permanent coating that may modulate the surface characteristics of the weighting agent. While this may be useful for applications in different base fluids, the permanency of the coating locks the particulate weighting agent into a single characteristic specific gravity and surface type. Moreover, such permanent coatings may hinder cleanup and removal of the weighting agent when an operation is complete.

### SUMMARY OF THE INVENTION

The present invention relates to additives used in treatment fluids in subterranean operations. More specifically, the present invention relates to particulate weighting agents comprising removable coatings and methods of using the same in treatment fluids as part of subterranean operations such as drilling and cementing operations.

In some embodiments, the present invention provides methods comprising providing treatment fluids for use in subterranean formations, the treatment fluid comprising coated particulate weighting agents comprising core weighting agents having a first specific gravity and removable polymer coatings having a second specific gravity, the first specific gravity and the second specific gravity are not the same, introducing the treatment fluids into the subterranean formations, and allowing a portion of the removable polymer coatings to be removed to alter the specific gravity of the coated particulate weighting agents down hole.

In other embodiments, the present invention provides methods comprising providing treatment fluids for use in subterranean formations comprising weighting agents, the weighting agents comprising particulate metal oxides, and polymers optionally covalently linked to the metal oxide particles, and introducing the treatment fluids into the subterranean formations, wherein the weighting agents re configured to prevent or reduce agglomeration and to allow at least a portion of the polymers to be removed to effect a change in density in the weighting agents down hole, and wherein the weighting agents are sized to prevent or reduce sag.

In still other embodiments, the present invention provides methods comprising providing drilling fluids comprising coated particulate weighting agents, the coated particulate weighting agents comprising, particulate metal oxides and polymers optionally covalently linked to the particulate metal oxides, and introducing the drilling fluids into subterranean formations, wherein the weighting agents are configured to prevent or reduce agglomeration and to allow at least a portion of the polymer to be removed to effect a change in density in the weighting agents down hole, and wherein the weighting agents are sized to prevent or reduce sag.

In yet still other embodiments, the present invention provides methods comprising providing cementing fluids comprising coated particulate weighting agents, the coated particulate weighting agents comprising, particulate metal oxides and polymers optionally covalently linked to the particulate metal oxides, introducing the cementing fluids into subterranean formations via wellbore casing strings, and allowing the cementing fluids to set to provide set cement sheaths, wherein the weighting agents are configured to prevent or reduce agglomeration and to allow at least a portion of the polymers to be removed to effect a change in density in the weighting agents down hole and wherein the weighting agents are sized to prevent or reduce sag.

In yet still further embodiments, the present invention provides methods comprising providing treatment fluids for use in subterranean formations, the treatment fluid comprising coated particulate weighting agents comprising core weighting agents having a first specific gravity and removable coatings having a second specific gravity, the first specific gravity and the second specific gravity are not the same, introducing the treatment fluids into the subterranean formations, and allowing a portion of the removable coatings to be removed to alter the specific gravity of the coated particulate weighting agents down hole.

The features and advantages of the present invention will be readily apparent to those skilled in the art upon a reading of the description of the preferred embodiments that follows.

### DETAILED DESCRIPTION

The present invention relates to additives used in treatment fluids in subterranean operations. More specifically, the present invention relates to particulate weighting agents comprising removable coatings and methods of using the same in treatment fluids as part of subterranean operations such as drilling and cementing operations.

Of the many advantages of the invention, embodiments disclosed herein provide a weighting agent that may be purposefully triggered to change its density. As used herein, density and specific gravity are generally used interchangeably. The specific gravity generally is referenced relative to water at 8.314 lb/gal. In some such embodiments, changes in specific gravity may be programmed quantized changes that can be effected in situ down hole during or at the end of a subterranean operation. In other embodiments, the changes in specific gravity may comprise a gradual continuum.

The coated, particulate weighting agents disclosed herein may improve the transport properties when micronized particulate weighting agents are employed. When no longer needed, the coating may be removed, thus facilitating cleanup by removal of the coating once an operation is complete. In some such embodiments, removal may comprise the complete dissolution of the coating material. Once this is accomplished, the weighting agent specific gravity or surface wettability may be sufficiently altered to allow easy removal. In some embodiments, after removal of a coating from the particulate weighting agent, the particulate weighting agent itself may be removable by dissolution. In some embodiments, removal of a portion of a coating on a weighting agent may improve suspension of the particulate weighting agent.

In some embodiments, particulate weighting agents may comprise different coating layers with different characteristics that may provide, for example, changes in wettability of the surface. Yet another advantage is that the coating may have a specific gravity less than core particulate weighting agent, such that when the coating is removed from the coated particulate weighting agent, there is an increase in specific gravity of the resulting particulate. Still further, in some embodiments, the coating may have a specific gravity that is higher than the core particulate weighting agent. Upon removal of the coating, the core particulate weighting agent will experience a decrease in specific gravity. This may allow the particulate weighting agents to rise in the fluid and provide easier cleanup.

In some embodiments, the removable coating may comprise a swellable polymer, wherein the swelling of the polymer may be used to increase the physical size or specific gravity of the weighting agent. In some such embodiments, the swollen polymer coating may have a specific gravity greater than the specific gravity of the core particulate weighting agent. Thus, as described above, removal of such swellable polymers may lead to a decrease in specific gravity for the remaining core particulate weighting agent.

Finally, with the wide array of potential mechanisms available for polymer removal, it may be possible to remove the polymer under highly defined conditions that may include, for example, chemical, photochemical, and mechanical means, as well as the use of temperature and/or pressure. Such removal may be triggered by an operator, or may be designed into a self-degrading coating with defined parameters for gradual shedding.

In some embodiments, the present invention provides methods comprising the steps of providing treatment fluids for use in subterranean formations. The treatment fluids comprising coated particulate weighting agents comprising core weighting agents and removable coatings, wherein the coated particulate weighting agents have specific gravities that differ from specific gravities of the core weighting agents. The methods further comprise introducing the treatment fluids into the subterranean formations, and allowing portions of the removable coatings to be removed to alter the specific gravity of the coated particulate weighting agents down hole.

As used herein, the term “treatment fluid” includes any fluid used in drilling, cementing, stimulation, completion, fracking, or any operation conducted in a subterranean location that may employ a weighting agent to alter the density of the fluid. The term “treatment” does not imply any particular action by the fluid relative to the subterranean formation. Treatment fluids may include a base fluid comprising a hydrocarbon, water, or mixtures thereof (e.g., emulsions, invert emulsions, foamed fluids, etc.). In addition to the coated particulate weighting agents disclosed herein, treatment fluids may include other additives such as viscosifiers, emulsifiers, proppants, pH modifying agents, cementing compositions, lost circulation materials, corrosion inhibitors, other subterranean treatment fluid additives, and the like, depending on the function of the treatment fluid.

As used herein, the term “weighting agent” refers to particulates used to modulate the density of the treatment fluid. In particular, weighting agents employed in methods of the invention may be used to increase the specific gravity of the treatment fluids.

As used herein, the term “particulate” refers to particles having dimensions ranging from about 1 nm to about 1200 microns. In some embodiments, the particulate weighting agents may be nanoparticles ranging in size from about 1 nm to about 100 nm, including any value in between or fractions thereof. In some embodiments, the particulate weighting agents may range in size from about 1 nm to about 500 nm, including any value in between or fractions thereof. In some embodiments, the particulate weighting agents may range in size from about 0.5 microns to about 1 micron, including any fractional value in between. In some such embodiments, the particulates may be referred to as sub-micron particles. Sub-micron particles may be distinguished from nanoparticles based on bulk matter behavior of sub-micron particles versus quantum behavior of nanoparticles. In some embodiments, particulates may range in size from about 1 micron to about 10 microns, including any value in between or fractions thereof. In some embodiments, particulates may range in size from about 2 microns to about 5 microns, including any value in between or fractions thereof.

Any of the aforementioned ranges of sized particulates may be accessed via micronization techniques as known in the art. As used herein, the term “micronized” refers to particulates that have been processed to provide particle sizes on micron scale or less. For example, micronized particles may have an effective diameter from between about 1 micron to about 10 microns in some embodiments, and from about 1 micron to about 5 microns in other embodiments, including any value in between or fractions thereof. The effective diameter refers to an average particle diameter based on an idealized spherical geometry, with the understanding that the particles may exhibit imperfections that cause the particle to deviate from perfect spherical shape. The term “micronized” also encompasses sub-micron-sized particles including particles less than about 1 micron. Sub-micron particles also include nanometer scale particulates ranging in size from about 1 nanometer to about 1000 nanometers, the distinction between bulk and quantum behavior notwithstanding. Thus, where quantum behavior may be evident, the particulates may more appropriately be referred to as nanoparticles.

Micronized particulates are accessed via any methods known in the art. Such methods include milling, bashing, grinding, and various methods employing supercritical fluids such as the RESS process (Rapid Expansion of Supercritical Solutions), the SAS method (Supercritical Anti-Solvent) and the PGSS method (Particles from Gas Saturated Solutions).

As used herein, the term “coated,” when used in reference to the relationship between the polymer and the particulate weighting agent, encompasses either encapsulation, i.e. non-covalent linkage, or chemical bonding of the removable about the surface of the particulate weighting agent. Bonding motifs include, for example, covalent bonding and ionic bonding. In some embodiments, bonding may include metal-ligand coordination chemistry. In some embodiments, the chemical bonding provided may be substantially irreversible, meaning that essentially forcing conditions may needed to sever the bonding between the weighting agent and the polymer. Such resistance, notwithstanding, the polymer may still be degradable and have the capacity to have at least a portion removed. In some embodiments, the chemical bonding provided may be moderately reversible. In some such embodiments, reversible attachment may include cleavage of the polymer from the weighting agent under special reaction conditions such as base labile detachment, acid labile detachment, photolabile detachment, oxidative or reductive detachment, and the like. “Coated” also encompasses the use of smaller organic fragments, such as linkers, to indirectly connect the removable coating and the particulate weighting agent. Linkers may be of any type commonly employed in the art of solid phase synthesis. Linkers may include oligomers, such as peptides, polyethylene glycols, propylene glycols, and the like.

In some embodiments, providing the treatment fluid may include providing a fluid intended for use as a drilling fluid. The methods of the invention may include the use of drilling fluids to control formation pressure. In some such embodiments, the drilling fluid may include the coated particulate weighting agents disclosed herein along with viscosifiers, other densifying additives such as brines, and other agents depending on the nature of the of the formation being drilled. Drilling fluids may be formulated to be thixotropic to aid in the removal of drill cuttings from the wellbore. Drilling fluids may further include bridging agents, lost circulation materials, and other agents to provide zonal isolation in porous formations. Drilling fluids may include other additives to minimize formation damage, provide lubrication during drilling and provide cooling to the drill bit.

In some embodiments, the drilling fluid may be a water-based drilling mud. In some embodiments, such a mud may include bentonite clay as a gellant, with weighting agents disclosed herein. Various thickeners may be employed to modulate the viscosity of the fluid. Exemplary thickeners may include, without limitation, xanthan gum, guar gum, glycol, carboxymethylcellulose (polyanionic cellulose, PAC or CMC), scleroglucan gum, synthetic hectorite, hydroxyethyl cellulose (HEC), diutan gum or starch, or any combination thereof. In some embodiments, a drilling fluid according to the present invention may include, deflocculants to reduce viscosity when employing clay-based muds; anionic polyelectrolytes, such as acrylates, polyphosphates, lignosulfonates or tannic acid derivates such as quebracho. Other additives may include lubricants, shale inhibitors, fluid loss control additives to control loss of drilling fluids into permeable formations, anti-foaming agents, pH-modulating additives, antimicrobial agents, H₂S/CO₂ and/or oxygen scavengers, corrosion inhibition agents.

In some embodiments, a drilling fluid according to the present invention may be an oil-based drilling mud. As used herein, “oil-based drilling mud” includes invert-emulsion oil muds. Oil-based mud may include a petroleum product such as diesel fuel as a base fluid. Oil-based muds maybe used to provide increased lubricity, enhanced shale inhibition, and greater cleaning abilities with lower viscosity. Oil-based muds also withstand greater heat without breaking down. Any of the additives described herein above maybe included in the oil based mud in conjunction with the weighting agents disclosed herein.

In some embodiments, the drilling fluid is a synthetic-based mud (SBM). SBMs may include systems based on commercially available formulations such as the ENCORE® fluid (on the world-wide web at halliburton.com/hpht, Halliburton, Houston, Tex.). Any such commercial formulation maybe modified by inclusion of weighting agents disclosed herein.

The base fluid, or carrier fluid, suitable for use in the drilling fluids of the present invention may include any of a variety of fluids suitable for use in a drilling fluid. Examples of suitable carrier fluids include, but are not limited to, aqueous-based fluids (e.g., water, oil-in-water emulsions), oleaginous-based fluids (e.g., invert emulsions). In certain embodiments, the aqueous fluid may be foamed, for example, containing a foaming agent and entrained gas. In certain embodiments, the aqueous-based fluid comprises an aqueous liquid. Examples of suitable oleaginous fluids that may be included in the oleaginous-based fluids include, but are not limited to, alpha-olefins, internal olefins, alkanes, aromatic solvents, cycloalkanes, liquefied petroleum gas, kerosene, diesel oils, crude oils, gas oils, fuel oils, paraffin oils, mineral oils, low-toxicity mineral oils, olefins, esters, amides, synthetic oils (e.g., polyolefins), polydiorganosiloxanes, siloxanes, organosiloxanes, ethers, acetals, dialkylcarbonates, hydrocarbons, and combinations thereof; in certain embodiments, the oleaginous fluid may comprise an oleaginous liquid.

Generally, according to the present invention, the carrier fluid may be present in a treatment fluid in an amount sufficient to form a pumpable fluid. By way of example, the carrier fluid may be present in a drilling fluid according to the present invention in an amount in the range of from about 20% to about 99.99% by volume of the drilling fluid, including any value in between and fractions thereof. One of ordinary skill in the art with the benefit of this disclosure will recognize the appropriate amount of carrier fluid to include within the drilling fluids of the present invention in order to provide a drilling fluid for a particular application.

In addition to the carrier fluid, the coated particulate weighting agent may be present in the drilling fluid in an amount sufficient for a particular application. For example, the coated particulate weighting agent may be included in a drilling fluid to provide a particular density. In certain embodiments, the coated particulate weighting agent may be present in the drilling fluid in an amount up to about 60% by volume of the drilling fluid (v %) (e.g., about 5%, about 15%, about 20%, about 25%, about 30%, about 35%, about 40%, about 45%, about 50%, about 55%, and about 60%, including all values in between and fractions thereof). In certain embodiments, the weighting agent may be present in the drilling fluid in an amount in a range from about 10 v % to about 60 v %.

In accordance with embodiments disclosed herein, at least a portion of the removable coating on the coated particulate weighting agent may be removed before, during, or after a subterranean operation, such as drilling operations, to alter the specific gravity of the remaining particulate weighting agent. In some embodiments, removing at least a portion of the coating comprises chemically removing at least a portion of the coating, while in other embodiments, removing at least a portion of the coating comprises mechanical removal. In some embodiments, removing at least a portion of the coating may comprise enzymatic removal. In some embodiments, removing at least a portion of the coating may comprise any combination of chemical, mechanical, and enzymatic techniques.

Removing at least a portion of the coating by chemical means may include, without limitation, treatments with acids, oxidizers, photolysis to break photolabile bonds, or solubilizing/dissolving a portion of the coating. Mechanical means may include, without limitation, physical breaking off a portion of the coating. In one specific embodiment, a coating may comprise a glass sphere that may be removed by rupturing the glass under pressure, for example, to release the core particulate weighting agent. Enzymatic methods may include enzymes capable of hydrolyzing ester bonds, amide bonds and the like.

In some embodiments of the present invention, providing the treatment fluid entails providing a cementing fluid comprising the weighting agents disclosed herein. In some embodiments, some such methods of the invention further include allowing the cementing fluid to set in an area in the subterranean formation.

Cementing fluids include any cement composition comprising a cementitious particulate. Cementing fluids may include any hydraulic or non-hydraulic cement composition, such as a Portland or Sorel cement, respectively. Suitable examples of hydraulic cements that may be used include, but are not limited to, those that comprise calcium, aluminum, silicon, oxygen, and/or sulfur, which set and harden by reaction with water. Examples include, but are not limited to, Portland cements, pozzolanic cements, gypsum cements, calcium phosphate cements, high alumina content cements, silica cements, high alkalinity cements, and mixtures thereof. Cementing fluids may include any composition used in the formation of set cement sheath in a wellbore. Cementing fluids also may include or comprise cementing kiln dust (CKD) fly ash, pumice, or slag and other additives as recognized by one skilled in the art. In some cases, cementing kiln dust (CKD) may comprise all or nearly all of the cementitious material.

Cementing fluids according to the present invention may include lost circulation materials, defoaming agents, foaming agents, plastic fibers, carbon fibers or glass fibers to adjust a ratio of the compressive strength to tensile strength (CTR), elastomers, and rubber, accelerator or retarders to modulate the setting time, and the like, any of which may be used in any combination. In some embodiments, weighting agents disclosed herein are used in conjunction with spacer fluids ahead of cementing fluids. In some such embodiments, the spacer fluid may employ weighting agents disclosed herein, while the cementing fluid does not require a weighting agent.

One skilled in the art will appreciate that while drilling and cementing fluids are described herein above, other subterranean treatment fluids may employ weighting agents as disclosed herein, for example, those that may benefit from the additional weight provided by the weighting agents of the present invention or any of the advantages disclosed herein. Any such treatment fluid maybe oil-based, water-based, or a water-oil mixture and/or emulsions.

In some embodiments, the treatment fluid may be introduced into a subterranean formation or a particular zone in a subterranean formation. While the most common methods for introducing fluids into a formation comprise pumping the fluid into the formation via the casing string, other treatment fluids may be delivered in the annulus between the casing string and the wall of the formation. In some embodiments, a treatment fluid maybe delivered via the casing string and then into targeted fractures within the formation. In some embodiments, the treatment fluid comprising weighting agents disclosed herein are introduced into fractures created by a perforation gun. In some such embodiments, the weighting agent is part of a fracturing fluid.

In some embodiments, treatment fluids employing weighting agents disclosed herein may be useful during 1) drilling, 2) cementing, 3) completion (including perforation), 4) well intervention or work-over, 5) hydraulic fracturing or acidification and 6) as packer fluid (fluid left between surface casing and production tubing, above reservoir isolating packer). The skilled artisan will recognize the utility of treatment fluids incorporating weighting agents disclosed herein in other applications.

In some embodiments, the coated particulate weighting agent comprises a metal oxide comprising one selected from the group consisting of manganese, magnesium, iron, titanium, silicon, zinc, and any combination thereof.

In some embodiments, the coated particulate weighting agent comprises a core that is a metal sulfate or sulfide, such as barium sulfate, or mercury sulfide (HgS). In some embodiments, the core of the particulate weighting agent comprises a silicate. In some embodiments, the core of the particulate weighting agent may comprise any material with a specific gravity greater than about 2.2. In some such embodiments, the core particulate weight agent may be insoluble or substantially insoluble in the wellbore treatment fluids. In some embodiments, methods of the invention employ a core particulate weighting agent that may be any conventional weighting agent such as barite, precipitated barite, sub-micron precipitated barite, hematite, ilmentite, manganese tetraoxide, galena, and calcium carbonate. The combined core particulate weighting agent and its removable coating may be present in the drilling fluid in an amount sufficient for a particular application. For example, the coated particulate weighting agent may be included in the drilling fluid to provide a particular density. In certain embodiments, the coated particulate weighting agent may be present in the drilling fluid in an amount up to about 70% by volume of the drilling fluid (v %) (e.g., about 5%, about 15%, about 20%, about 25%, about 30%, about 35%, about 40%, about 45%, about 50%, about 55%, about 60%, about 65%, etc.). In certain embodiments, the weighting agent may be present in the drilling fluid in an amount of 10 v % to about 40 v %.

By way of example, the treatment fluid may have a density of greater than about 9 pounds per gallon (“lb/gal”). In certain embodiments, the treatment fluid may have a density of about 9 lb/gal to about 22 lb/gal. In some embodiments, the core particulate weighting agent may be a metal oxide particle. In some such embodiments, the metal oxide particle may have an effective diameter that is less than about 5 microns. For example, the metal oxide particle maybe about 1 micron, about 2 microns, about 3 microns, about 4, microns or about 5 microns, including fractions thereof. In some embodiments, the metal oxide particle may be less than about 1 micron. Sub-micron metal oxide particles may have a particle size distribution such that at least 90% of the particles have a diameter (“d₉₀”) below about 1 micron. In certain embodiments, the sub-micron metal oxide particles may have a particle size distribution such that at least 10% of the particles have a diameter (“d₁₀”) below about 0.2 microns, 50% of the particles have a diameter (“d₅₀”) below about 0.3 microns and 90% of the particles have a diameter (d₉₀) below about 0.5 micron.

In some embodiments, the metal oxide particles have at least one dimension that is about 500 nm or less. In some embodiments, the metal oxide maybe about 500 nm, about 400 nm, about 300 nm, about 200 nm, about 100 nm, about 50 nm, about 10 nm, including any value in between and fractions thereof. Advantageously, in some embodiments, where the particle is smaller than about 500 nm, the treatment fluid need not include any suspending agent to maintain suspension of the coated particulate weighting agent. Thus, in some embodiments, the coated particulate weighting agent is capable of self-suspending without the aid of a suspending agent. In some such embodiments, the treatment fluid may exclude viscosifying agents, although, this will depend on the actual function of the treatment fluid. For example, a viscosifying agent may still be needed in a drilling fluid to aid in removing drilling cuttings. The use of smaller particle sizes may also help prevent sagging when used with or without suspending agents.

In some embodiments, the metal oxide particle may comprise a standard size weighting agent particle size including a d₅₀ of about 20 microns and a d₉₀ of about 70 microns. In some such embodiments, the treatment fluid may include suspending agents to aid in preventing the settling of the weighting agent.

As described above, methods of the invention may use coated particulate weighting agents comprising a metal oxide particle comprising any number of metals, metalloids, or semi-conducting metals. In some embodiments, the metal oxide comprises a metal selected from the group consisting of manganese, iron, titanium, silicon, zinc, and any combination thereof. While the oxide form of a metal may be particularly useful due to its ability to provide a point of attachment for chemically bonding a polymer or linker/polymer combination, the skilled artisan will recognize that metal forms other than oxides may serve this purpose. For example, in some embodiments, the metal may comprise a zero-valent metal- or metal ion-polymer pairing in which at least a portion of the polymer is capable of linking to the zero-valent metal or metal ion via ligand coordination chemistry. As used herein, zero-valent means a metal having no formal charge associated with higher oxidations states. When engaging in ligand coordination, the polymers may contain organic functional groups for this purpose including, without limitation, alcohols, carboxylates, amines, thiols (mercaptans), or other heteroatom function groups serving as a ligand donor to the zero-valent metal or metal ion.

In some embodiments, the metal oxide particle comprises manganese tetraoxide (Mn₃O₄). In some such embodiments, the particle is provided as a nanoparticle. Manganese tetraoxide may be particularly useful in the present invention due to the ability to degrade the particulate weighting agent by dissolution of the manganese tetraoxide upon treatment with an acid source.

In some embodiments, the coating may be an organic polymer, a glass, a silicone, or any other coating capable of being at least partially removable. In some embodiments, the coating may comprise a polymer. In some such embodiments, the polymer may be hydrophobic. Hydrophobic polymers may include any degree of crosslinking, but generally lack the presence of substantial numbers of heteroatoms that confer polar character to the polymer. The term “hydrophobic polymer” is used herein to mean any polymer resistant to wetting, or not readily wet, by water, that is, having a lack of affinity for water. Examples of hydrophobic polymers may include, without limitation, polyolefins, such as polyethylene, poly(isobutene), poly(isoprene), poly(4-methyl-1-pentene), polypropylene, ethylene-propylene copolymers, ethylene-propylene-hexadiene copolymers, and ethylene-vinyl acetate copolymers; metallocene polyolefins, such as ethylene-butene copolymers and ethylene-octene copolymers; styrene polymers, such as poly(styrene), poly(2-methylstyrene), and styrene-acrylonitrile copolymers having less than about 20 mole-percent acrylonitrile; vinyl polymers, such as poly(vinyl butyrate), poly(vinyl decanoate), poly(vinyl dodecanoate), poly(vinyl hexadecanoate), poly(vinyl hexanoate), poly(vinyl octanoate), and poly(methacrylonitrile); acrylic polymers, such as poly(n-butyl acetate), and poly(ethyl acrylate); methacrylic polymers, such as poly(benzyl methacrylate), poly(n-butyl methacrylate), poly(isobutyl methacrylate), poly(t-butyl methacrylate), poly(t-butylaminoethyl methacrylate), poly(do-decyl methacrylate), poly(ethyl methacrylate), poly(2-ethylhexyl methacrylate), poly(n-hexyl methacrylate), poly(phenyl methacrylate), poly(n-propyl methacrylate), and poly(octadecyl methacrylate); polyesters, such a poly(ethylene terephthalate) and poly(butylene terephthalate); and polyalkenes and polyalkynes, such as polybutylene and polyacetylene.

The term “polyolefin” is used herein to mean a polymer prepared by the addition polymerization of one or more unsaturated monomers that contain only carbon and hydrogen atoms. Examples of such polyolefins may include, without limitation, polyethylene, polypropylene, poly(1-butene), poly(2-butene), poly(1-pentene), poly(2-pentene), poly(3-methyl-1-pentene), poly(4-methyl-1-pentene), and the like. In addition, such term is meant to include blends of two or more polyolefins and random and block copolymers prepared from two or more different unsaturated monomers.

In some embodiments, methods of the invention employ hydrophobic polymers to provide coated particulate weighting agents that are superhydrophobic. In some such embodiments, the hydrophobic polymer may include fluorinated polyolefins and other perfluoroalkyl polymers and perfluoropolyethers. In some such embodiments, the weighting agents constructed form such polymers may be particularly well suited for oil-based treatment fluids, including oil-based drilling muds.

In some embodiments, the polymer is hydrophilic, while in other embodiments the polymer is an amphiphilic copolymer comprising at least one hydrophobic portion and at least one hydrophilic portion. Hydrophilic polymers may include any array of heteroatoms that confer polarity to the polymer. Moreover, some such polymers may contain organic functional groups capable of supporting a formal charge, such as carboxylates, amines/ammonium groups, including mono alkyl ammonium, dialkyl ammonium, trialkylammonium, and tetraalkyl ammonium salts, sulfonates or alkyl sulfonates, phosphates or alkyl phosphates, or other charged functional groups. Examples of hydrophilic polymers may include, without limitation, polyethylene glycol (PEG), poly(vinyl alcohol), polyvinylpyrrolidone, chitosan, starch, sodium carboxymethylcellulose, cellulose, hydroxyethyl cellulose, sodium alginate, guar, scleroglucan, diutan, welan, gellan, xanthan, and carrageenan.

Other suitable hydrophilic polymers may include homopolymers, copolymers, or terpolymers including, without limitation, polyacrylamides, polyvinylamines, poly(vinylamines/vinyl alcohols), alkyl acrylate polymers, and combinations thereof. Additional examples of alkyl acrylate polymers may include polydimethylaminoethyl methacrylate, polydimethylaminopropyl methacrylamide, poly(acrylamide-dimethylaminoethyl methacrylate), poly(methacrylic acid-dimethylaminoethyl methacrylate), poly(2-acrylamido-2-methyl propane sulfonic acid/dimethylaminoethyl methacrylate), poly(acrylamide-dimethylaminopropyl methacrylamide), poly (acrylic acid/dimethylaminopropyl methacrylamide), poly(methacrylic acid-dimethylaminopropyl methacrylamide), and combinations thereof. In certain embodiments, the hydrophilic polymers may comprise a polymer backbone and reactive amino groups in the polymer backbone or as pendant groups, the reactive amino groups capable of engaging a zero-valent metal or metal ion ligand coordination sphere. In some embodiments, the hydrophilic polymers may comprise dialkyl amino pendant groups. In some embodiments, the hydrophilic polymers may comprise a dimethyl amino pendant group and a monomer comprising dimethylaminoethyl methacrylate or dimethylaminopropyl methacrylamide. In certain embodiments, the hydrophilic polymers may comprise a polymer backbone that comprises polar heteroatoms, wherein the polar heteroatoms present within the polymer backbone of the hydrophilic polymers include oxygen, nitrogen, sulfur, or phosphorous. Suitable hydrophilic polymers that comprise polar heteroatoms within the polymer backbone include, without limitation, homopolymer, copolymer, or terpolymers, such as, but not limited to, celluloses, chitosans, polyamides, polyetheramines, polyethyleneimines, polyhydroxyetheramines, polylysines, polysulfones, gums, starches, and combinations thereof. In some embodiments, the starch maybe a cationic starch. A suitable cationic starch maybe formed by reacting a starch, such as corn, maize, waxy maize, potato, tapioca, or the like, with the reaction product of epichlorohydrin and trialkylamine.

In some embodiments, the polymer employed in methods of the invention may be a synthetic polymer or a naturally occurring polymer. In some embodiments, the polymer may be based on amino acids and may be a protein. In some embodiments, the polymer may be based on polysaccharides or glycoproteins. In some embodiments, the polymer may be a PEG-based polymer. In some embodiments, the polymer may be selected to swell in polar solvent such as water. In some embodiments, the polymer may be selected to swell in a nonpolar solvent, such as a hydrocarbon-based solvent like diesel. In some embodiments, the polymer may be selected to resist swelling regardless of what solvent is employed.

In some embodiments, smart polymers may be employed to allow a change in the polymers character, including, without limitation, polarity molecular weight, and degree of crosslinking. In some embodiments, the polymer may comprise a block copolymer. In some such embodiments, the block copolymer may be a diblock, triblock, tetrablock, or other multiblock copolymer. In some embodiments, the polymer may comprise a graft copolymer. In some embodiments, the polymer may be a periodic copolymer. In some embodiments, the polymer may be an alternating copolymer. In some embodiments, the polymer may be an interpolymer.

In some embodiments, the linked polymer may be selected to be degradable. Suitable examples of degradable polymers that may be used in accordance with the present invention include, but are not limited to, those described in U.S. Pat. No. 7,204,312, titled “Compositions and methods for the delivery of chemical components in subterranean well bores” to Roddy et al., the entire disclosure of which is hereby incorporated by reference. Specific examples include homopolymers, random, block, graft, and star- and hyper-branched aliphatic polyesters. Such suitable polymers may be prepared by polycondensation reactions, ring-opening polymerizations, free radical polymerizations, anionic polymerizations, carbocationic polymerizations, coordinative ring-opening polymerizations, as well as by any other suitable process.

Examples of suitable degradable polymers that may be used in conjunction with the methods of this invention include, but are not limited to, aliphatic polyesters; poly(lactides); poly(glycolides); poly(ε-caprolactones); poly(hydroxy ester ethers); poly(hydroxybutyrates); poly(anhydrides); polycarbonates; poly(orthoesters); poly(amino acids); poly(ethylene oxides); poly(phosphazenes); polyether esters, polyester amides, polyamides, and copolymers or blends of any of these degradable polymers, and derivatives of these degradable polymers. The term “copolymer” as used herein is not limited to the combination of two polymers, but includes any combination of polymers, e.g., terpolymers and the like.

As referred to herein, the term “derivative” is defined herein to include any compound that is made from one of the listed compounds, for example, by replacing one atom in the base compound with another atom or group of atoms. Of these suitable polymers, aliphatic polyesters such as poly(lactic acid), poly(anhydrides), poly(orthoesters), and poly(lactide)-co-poly(glycolide) copolymers maybe beneficially employed, especially poly(lactic acid) and poly(orthoesters). Other degradable polymers that are subject to hydrolytic degradation also may be suitable. One's choice may depend on the particular application or use and the conditions involved. Other guidelines to consider include the degradation products that result, the time for required for the requisite degree of degradation, and the desired result of the degradation, such as removal of the weighting agent.

Suitable aliphatic polyesters have the general formula of repeating units shown below:

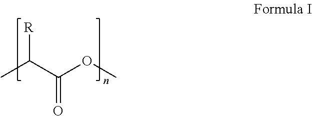

where n is an integer between 75 and 10,000 and R is selected from the group consisting of hydrogen, alkyl, aryl, alkylaryl, acetyl, heteroatoms, and mixtures thereof. In certain embodiments of the present invention wherein an aliphatic polyester is used, the aliphatic polyester may be poly(lactide). Poly(lactide) is synthesized either from lactic acid by a condensation reaction or, more commonly, by ring-opening polymerization of cyclic lactide monomer. Since both lactic acid and lactide may achieve the same repeating unit, the general term poly(lactic acid) as used herein is included in Formula I without any limitation as to how the polymer was made (e.g., from lactides, lactic acid, or oligomers), and without reference to the degree of polymerization or level of plasticization.

The lactide monomer exists generally in three different forms: two stereoisomers (L- and D-lactide) and racemic D,L-lactide (/meso-lactide). The oligomers of lactic acid and the oligomers of lactide are defined by the formula:

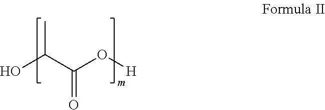

where m is an integer in the range of from greater than or equal to about 2 to less than or equal to about 75. In certain embodiments, m may be an integer in the range of from greater than or equal to about 2 to less than or equal to about 10. These limits may correspond to number average molecular weights below about 5,400 and below about 720, respectively.

The chirality of the lactide units provides a means to adjust, inter alia, degradation rates, as well as physical and mechanical properties. Poly(L-lactide), for instance, is a semicrystalline polymer with a relatively slow hydrolysis rate. This could be desirable in applications or uses of the present invention in which a slower degradation of the degradable material is desired. Poly(D,L-lactide) may be a more amorphous polymer with a resultant faster hydrolysis rate. This may be suitable for other applications or uses in which a more rapid degradation may be appropriate. The stereoisomers of lactic acid may be used individually, or may be combined in accordance with the present invention. Additionally, they may be copolymerized with, for example, glycolide or other monomers like E-caprolactone, 1,5-dioxepan-2-one, trimethylene carbonate, or other suitable monomers to obtain polymers with different properties or degradation times. Additionally, the lactic acid stereoisomers maybe modified by blending high and low molecular weight polylactide or by blending polylactide with other polyesters, in embodiments wherein polylactide is used as the degradable material, certain preferred embodiments employ a mixture of the D and L stereoisomers, designed so as to provide a desired degradation time and/or rate. Examples of suitable sources of degradable material are poly(lactic acids) that are commercially available from NatureWorks® of Minnetonka, Minn., under the trade names “300 ID” and “4060D.”

Aliphatic polyesters useful in the present invention may be prepared by substantially any of the conventionally known manufacturing methods such as those described in U.S. Pat. Nos. 6,323,307; 5,216,050; 4,387,769; 3,912,692; and 2,703,316, the entire disclosures of which are incorporated herein by reference.

Polyanhydrides are another type of degradable polymer that may be suitable for use in the present invention. Examples of suitable polyanhydrides include poly(adipic anhydride), poly(suberic anhydride), poly(sebacic anhydride), and poly(dodecanedioic anhydride). Other suitable examples include, but are not limited to, poly(maleic anhydride) and poly(benzoic anhydride).

The physical properties of degradable polymers may depend on several factors including, but not limited to, the composition of the repeat units, flexibility of the chain, presence of polar groups, molecular mass, degree of branching, crystallinity, and orientation. For example, short chain branches may reduce the degree of crystallinity of polymers while long chain branches may lower the melt viscosity and may impart, inter alia, extensional viscosity with tension-stiffening behavior. The properties of the material utilized further may be tailored by blending, and copolymerizing it with another polymer, or by a change in the macromolecular architecture (e.g., hyper-branched polymers, star-shaped, or dendrimers, and the like). The properties of any such suitable degradable polymers (e.g., hydrophobicity, hydrophilicity, rate of degradation, and the like) maybe tailored by introducing select functional groups along the polymer chains. For example, poly(phenyllactide) will degrade at about one-fifth of the rate of racemic poly(lactide) at a pH of 7.4 at 55° C. One of ordinary skill in the art, with the benefit of this disclosure, will be able to determine the appropriate functional groups to introduce to the polymer chains to achieve the desired physical properties of the degradable polymers.

In some embodiments, methods of the invention include a weighting agent in which the polymer is covalently linked to the core particulate weighting agent. In some embodiments, the polymer is linked via ionic bonding.

In some embodiments, the polymer is linked to any metal center, including for example, a metal oxide, via ligand coordination chemistry. As described herein above, the nature of the chemical bonding maybe configured to be substantially irreversible or moderately reversible. In some embodiments, the polymer is linked to the core particulate weighting agent via a linker molecule as described above.

Polymers employed in the present invention may vary in molecular weight and degree of cross-linking suitable for compatibility with the intended application of the weighting agent. For example, the molecular weight of the polymer and its degree of cross-linking may be chosen for any number of physical properties such as swellability, stiffness, strength, and toughness.

In some embodiments, the present invention provides a method comprising providing a treatment fluid for use in a subterranean formation comprising a coated particulate weighting agent, the coated particulate weighting agent comprising a micronized metal oxide particle and a polymer covalently linked to the metal oxide particle, the method further including introducing the treatment fluid into the subterranean formation. The method may further comprise removing at least a portion of the polymer.

In some such embodiments, the fluid is a drilling fluid or a cementing fluid as described herein. In some such embodiments, the metal oxide particle is a nanoparticle. In some such embodiments, the polymer comprises one selected from the group consisting of a hydrophobic polymer, a hydrophilic polymer, and a copolymer comprising at least one hydrophobic portion and at least one hydrophilic portion. In some such embodiments, the weighting agent is capable of self-suspending without the aid of a suspending agent.

In some embodiments, the particulate weighting agents disclosed herein are used to increase the treatment fluid density to provide at least one function selected from the group consisting of controlling formation pressure, maintaining borehole stability, and preventing the introduction of formation fluids into a borehole. Although the weighting agents are described herein are described in the context of treatment fluids for subterranean operations, other uses will be recognized by the skilled artisan.

In some embodiments, the core of the particulate weighting agent may be a material having a higher or lower specific gravity than the coating material. In methods of the invention, removing at least a portion of the coating, such as dissolving the coating, allows for a change in specific gravity. In the some embodiments, the specific gravity of the coating is higher than the core particulate weighting agent. In some such embodiments, methods disclosed herein may include a step of removing the core weighting agent after removal of the greater density coating after the remaining core particle floats to a top portion of the treatment fluid column. In some embodiments, the removable coating comprises one selected from the group consisting of a hydrophobic polymer, a hydrophilic polymer, an amphiphilic polymer and combinations thereof. In some such embodiments, combinations of coating may be used in layers and the layers may be selectively removable. In some such embodiments, removing a particular layer may result in exposing a surface of the coated particulate weighting agent having different surface characteristics. For example, an outer hydrophobic layer may be removed to expose a hydrophilic inner layer, or vice versa.

In some embodiments, the present invention provides methods comprising providing treatment fluids for use in subterranean formations comprising weighting agents, the weighting agents comprising particulate weighting agent materials, and a polymer covalently linked to the particulate weighting agent material, and introducing the treatment fluids into subterranean formations, wherein the weighting agents are configured to prevent or reduce agglomeration and to allow at least a portion of the polymers to be removed to effect changes in density in the weighting agents down hole, and wherein the weighting agents are sized to prevent or reduce sag.

In some embodiments, the present invention provides methods comprising providing drilling fluids comprising coated particulate weighting agents, the coated particulate weighting agents comprising, particulate weighting agents and polymers covalently linked to the particulate weighting agents, and introducing the drilling fluids into subterranean formations, wherein the weighting agents are configured to prevent or reduce agglomeration and to allow at least a portion of the polymer to be removed to effect changes in density in the weighting agents down hole, and wherein the weighting agents are sized to prevent or reduce sag.

In some embodiments, the present invention provides methods comprising providing cementing fluids comprising coated particulate weighting agents, the coated particulate weighting agents comprising a particulate metal oxide and a polymer covalently linked to the particulate metal oxide, introducing the cementing fluids into a subterranean formation via a wellbore casing string, and allowing the cementing fluid to set to provide a set cement sheath, wherein the weighting agents are configured to prevent or reduce agglomeration and to allow at least a portion of the polymers to be removed to effect changes in density in the weighting agents down hole and wherein the weighting agents are sized to prevent or reduce sag.

The exemplary coated, particulate weighting agents disclosed herein may directly or indirectly affect one or more components or pieces of equipment associated with the preparation, delivery, recapture, recycling, reuse, and/or disposal of the disclosed coated, particulate weighting agents. For example, the disclosed coated, particulate weighting agents may directly or indirectly affect one or more mixers, related mixing equipment, mud pits, storage facilities or units, fluid separators, heat exchangers, sensors, gauges, pumps, compressors, and the like used generate, store, monitor, regulate, and/or recondition the exemplary coated, particulate weighting agents. The disclosed coated, particulate weighting agents may also directly or indirectly affect any transport or delivery equipment used to convey the coated, particulate weighting agents to a well site or down hole such as, for example, any transport vessels, conduits, pipelines, trucks, tubulars, and/or pipes used to fluidically move the coated, particulate weighting agents from one location to another, any pumps, compressors, or motors (e.g., topside or down hole) used to drive the coated, particulate weighting agents into motion, any valves or related joints used to regulate the pressure or flow rate of the coated, particulate weighting agents, and any sensors (i.e., pressure and temperature), gauges, and/or combinations thereof, and the like. The disclosed coated, particulate weighting agents may also directly or indirectly affect the various down hole equipment and tools that may come into contact with the chemicals/fluids such as, but not limited to, drill string, coiled tubing, drill pipe, drill collars, mud motors, down hole motors and/or pumps, floats, MWD/LWD tools and related telemetry equipment, drill bits (including roller cone, PDC, natural diamond, hole openers, reamers, and coring bits), sensors or distributed sensors, down hole heat exchangers, valves and corresponding actuation devices, tool seals, packers and other wellbore isolation devices or components, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising the steps of:
providing a treatment fluid for use in a subterranean formation, the treatment fluid comprising a coated particulate weighting agent comprising a core weighting agent having a first specific gravity and a removable polymer coating having a second specific gravity;
wherein the first specific gravity and the second specific gravity are not the same;
introducing the treatment fluid into the subterranean formation; and
allowing a portion of the removable polymer coating to be removed to alter the specific gravity of the coated particulate weighting agent down hole.

2. The method of claim 1, wherein the treatment fluid comprises one selected from the group consisting of a drilling fluid, a cementing fluid, a fracking fluid, a completions fluid, a packer fluid and a workover fluid.

3. The method of claim 1, wherein the treatment fluid comprises a drilling fluid.

4. The method of claim 1, wherein the treatment fluid comprises a cementing fluid.

5. The method of claim 4, further comprising allowing the cementing fluid to set.

6. The method of claim 1, wherein the treatment fluid is oil based, water based, brine based, or a water-oil emulsion or combinations thereof.

7. The method of claim 1, wherein the coated particulate weighting agent comprises a metal oxide having an effective diameter in a range from about 1 to about 90 microns.

8. The method of claim 1, wherein the coated particulate weighting agent comprises a metal oxide having at least one dimension that is about 500 nm.

9. The method of claim 1, wherein the coated particulate weighting agent comprises a metal oxide comprising one selected from the group consisting of manganese, magnesium, iron, titanium, silicon, zinc, and any combination thereof.

10. The method of claim 1, wherein the removable polymer coating comprises one selected from the group consisting of a hydrophobic polymer, a hydrophilic polymer, an amphiphilic polymer, and combinations thereof.

11. The method of claim 1, wherein a portion of the removable polymer coating is covalently linked to the core weighting agent.

12. The method of claim 1, wherein the coated particulate weighting agent is capable of self-suspending without the aid of a suspending agent.

13. A method comprising:
providing a treatment fluid for use in a subterranean formation comprising a weighting agent, the weighting agent comprising:
a particulate metal oxide having a first specific gravity; and
a polymer having a second specific gravity optionally covalently linked to the metal oxide particle; and
introducing the treatment fluid into the subterranean formation;
wherein the weighting agent is configured to prevent or reduce agglomeration and to allow at least a portion of the polymer to be removed to effect a change in specific gravity in the weighting agent down hole; and
wherein the weighting agent is sized to prevent or reduce sag.

14. The method of claim 13, wherein the fluid is a drilling fluid or a cementing fluid.

15. The method of claim 13, wherein the particulate metal oxide is a nanoparticle.

16. The method of claim 13, wherein the polymer comprises one selected from the group consisting of a hydrophobic polymer, a hydrophilic polymer, and a copolymer comprising at least one hydrophobic portion and at least one hydrophilic portion.

17. The method of claim 13, wherein the weighting agent is capable of self-suspending without the aid of a suspending agent.

18. The method of claim 13, wherein the weighting agent is used to increase the treatment fluid density to provide at least one function selected from the group consisting of controlling formation pressure, maintaining borehole stability, and preventing the introduction of formation fluids into a borehole.

19. A method comprising:
providing a drilling fluid comprising a coated particulate weighting agent, the coated particulate weighting agent comprising,
a particulate metal oxide and a polymer optionally covalently linked to the particulate metal oxide; and
introducing the drilling fluid into a subterranean formation,
wherein the weighting agent is configured to prevent or reduce agglomeration and to allow at least a portion of the polymer to be removed to effect a change in specific gravity in the weighting agent down hole; and
wherein the weighting agent is sized to prevent or reduce sag.

20. A method comprising:
providing a cementing fluid comprising a coated particulate weighting agent, the coated particulate weighting agent comprising,
a particulate metal oxide and a polymer optionally covalently linked to the particulate metal oxide;
introducing the cementing fluid into a subterranean formation via a wellbore casing string; and
allowing the cementing fluid to set to provide a set cement sheath,
wherein the coated particulate weighting agent is configured to prevent or reduce agglomeration and to allow at least a portion of the polymer to be removed to effect a change in specific gravity in the weighting agent down hole; and
wherein the weighting agent is sized to prevent or reduce sag.

21. A method comprising the steps of:
providing a treatment fluid for use in a subterranean formation, the treatment fluid comprising a coated particulate weighting agent comprising a core weighting agent having a first specific gravity and a removable coating having a second specific gravity;
wherein the first specific gravity and the second specific gravity are not the same;
introducing the treatment fluid into the subterranean formation; and
allowing a portion of the removable coating to be removed to alter the specific gravity of the coated particulate weighting agent down hole.
